(19) United States
(12) Patent Application Publication
(10) Pub. No.: US 2025/0111797 A1
(43) Pub. Date: Apr. 3, 2025

(54) Method and System for Visualizing Problem Solving Results

(71) Applicant: MATA EDU, INC., Seoul (KR)

(72) Inventors: Tae Hyoung Oh, Seoul (KR); Du Seop Jung, Gyeonggi-do (KR)

(21) Appl. No.: 18/830,839

(22) Filed: Sep. 11, 2024

(30) Foreign Application Priority Data
Sep. 11, 2023 (KR) 10-2023-0120749

(51) Int. Cl. G09B 7/00

(52) U.S. Cl. CPC G09B 7/00

(57) ABSTRACT

According to one aspect of the present invention, there is provided a method for visualizing problem solving results, the method comprising the steps of: displaying information on a user's predicted correct answer rate for at least one problem in an area assigned to each of the at least one problem; and dynamically determining display status of the area assigned to a first problem with reference to the user's predicted correct answer rate for the first problem and the user's actual correctness/incorrectness result for the first problem.

### FIELD OF THE INVENTION

The present invention relates to a method and system for visualizing problem solving results.

### BACKGROUND

With the advancement of computer-related technology, attempts have been made to apply various computer-related technologies to education-related fields.

In order to enhance the learning effectiveness of a user (e.g., elementary school student, middle school student, or high school student), it may be necessary to provide specific feedback on the user's problem solving results.

According to traditional learning approaches, a user should solve a specific problem and determine whether the user has correctly answered the specific problem with reference to a solution explanation corresponding to the problem. Further, the user should proceed with his/her learning without knowing a predicted correct answer rate for the problem (i.e., a probability that a specific user answers the problem correctly), which results in a problem of failing to provide specific feedback on problem solving results (e.g., a comparison between the predicted correct answer rate and the user's problem solving results).

In this connection, the inventor(s) present a technique for allowing a user to visually receive feedback on learning by displaying information on the user's predicted correct answer rate for at least one problem, and dynamically determining display status of an area assigned to the at least one problem with reference to the predicted correct answer rate and actual correctness/incorrectness results.

### PRIOR ART DOCUMENTS

### Patent Documents

(Patent Document 1) Korean Laid-Open Patent Publication No. 10-2022-0005365 (2022.01.13)

### SUMMARY OF THE INVENTION

One object of the present invention is to solve all the above-described problems in the prior art.

Another object of the invention is to display information on a user's predicted correct answer rate for at least one problem in an area assigned to each of the at least one problem, and dynamically determine display status of the area assigned to a first problem with reference to the user's predicted correct answer rate for the first problem and the user's actual correctness/incorrectness result for the first problem.

Yet another object of the invention is to visually provide feedback on a user's learning.

Still another object of the invention is to enhance a user's learning effectiveness by visualizing problem solving results.

The representative configurations of the invention to achieve the above objects are described below.

According to one aspect of the invention, there is provided a method comprising the steps of: displaying information on a user's predicted correct answer rate for at least one problem in an area assigned to each of the at least one problem; and dynamically determining display status of the area assigned to a first problem with reference to the user's predicted correct answer rate for the first problem and the user's actual correctness/incorrectness result for the first problem.

According to another aspect of the invention, there is provided a system comprising: an area display unit configured to display information on a user's predicted correct answer rate for at least one problem in an area assigned to each of the at least one problem; and a display status determination unit configured to dynamically determine display status of the area assigned to a first problem with reference to the user's predicted correct answer rate for the first problem and the user's actual correctness/incorrectness result for the first problem.

In addition, there are further provided other methods and systems to implement the invention, as well as non-transitory computer-readable recording media having stored thereon computer programs for executing the methods.

According to the invention, it is possible to display information on a user's predicted correct answer rate for at least one problem in an area assigned to each of the at least one problem, and dynamically determine display status of the area assigned to a first problem with reference to the user's predicted correct answer rate for the first problem and the user's actual correctness/incorrectness result for the first problem.

According to the invention, it is possible to visually provide feedback on a user's learning.

According to the invention, it is possible to enhance a user's learning effectiveness by visualizing problem solving results.

### BRIEF DESCRIPTION OF THE DRAWINGS

FIG. 1 schematically shows the configuration of an entire system for visualizing problem solving results according to one embodiment of the invention.

FIG. 2 specifically shows the internal configuration of an information provision system according to one embodiment of the invention.

FIG. 3 illustratively shows a situation in which problem solving results are visualized according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

### Configuration of the Entire System

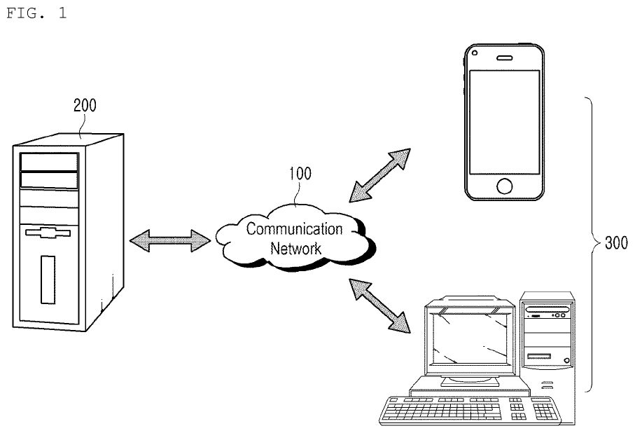

FIG. 1 schematically shows the configuration of the entire system for visualizing problem solving results according to one embodiment of the invention.

As shown in FIG. 1, the entire system according to one embodiment of the invention may comprise a communication network 100, an information provision system 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the information provision system 200 according to one embodiment of the invention may function to display information on a user's predicted correct answer rate for at least one problem in an area assigned to each of the at least one problem, and dynamically determine display status of the area assigned to a first problem with reference to the user's predicted correct answer rate for the first problem and the user's actual correctness/incorrectness result for the first problem.

The configuration and functions of the information provision system 200 according to the invention will be discussed in more detail below.

Next, the device 300 according to one embodiment of the invention is digital equipment capable of connecting to and then communicating with the information provision system 200, and any type of digital equipment having a memory means and a microprocessor for computing capabilities, such as a smart phone, a tablet, a smart watch, a smart band, smart glasses, a desktop computer, a notebook computer, a workstation, a personal digital assistant (PDA), a web pad, and a mobile phone, may be adopted as the device 300 according to the invention.

In particular, the device 300 may include an application (not shown) for assisting the user to be provided with the functions according to the invention from the information provision system 200. The application may be downloaded from the information provision system 200 or an external application distribution server (not shown). Meanwhile, the characteristics of the application may be generally similar to those of an area display unit 210, a display status determination unit 220, a communication unit 230, and a control unit 240 of the information provision system 200 to be described below. Here, at least a part of the application may be replaced with a hardware device or a firmware device that may perform a substantially equal or equivalent function, as necessary.

### Configuration of the Information Provision System

Hereinafter, the internal configuration of the information provision system 200 crucial for implementing the invention and the functions of the respective components thereof will be discussed.

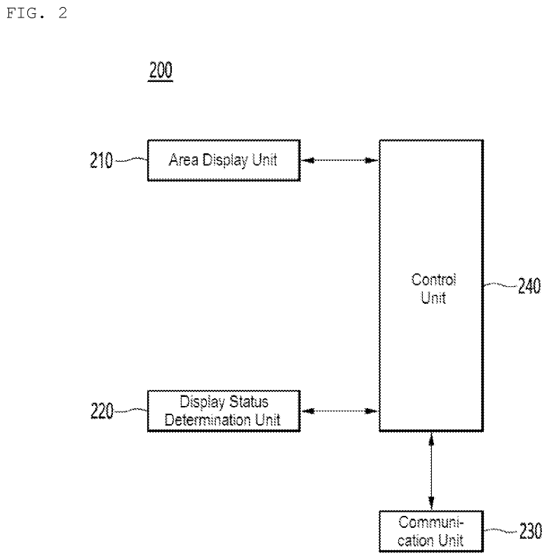

FIG. 2 specifically shows the internal configuration of the information provision system 200 according to one embodiment of the invention.

As shown in FIG. 2, the information provision system 200 according to one embodiment of the invention may comprise an area display unit 210, a display status determination unit 220, a communication unit 230, and a control unit 240. According to one embodiment of the invention, at least some of the area display unit 210, the display status determination unit 220, the communication unit 230, and the control unit 240 may be program modules to communicate with an external system (not shown). The program modules may be included in the information provision system 200 in the form of operating systems, application program modules, and other program modules, while they may be physically stored in a variety of commonly known storage devices. Further, the program modules may also be stored in a remote storage device that may communicate with the information provision system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the information provision system 200 has been described as above, and it will be apparent to those skilled in the art that at least a part of the components or functions of the information provision system 200 may be implemented in the device 300 or a server (not shown) or included in an external system (not shown), as necessary.

First, the area display unit 210 according to one embodiment of the invention may function to display information on a user's predicted correct answer rate for at least one problem in an area assigned to each of the at least one problem.

Specifically, the at least one problem according to one embodiment of the invention may include a problem that may be acquired online or offline. For example, the at least one problem according to one embodiment of the invention may include a problem that may be acquired from at least one of a database associated with the information provision system 200 (e.g., a math problem database or a Korean language problem database) and an external system (e.g., a web server). As another example, the at least one problem according to one embodiment of the invention may include a learning problem (e.g., math problem, English problem, or science problem) used for learning of a user (e.g., kindergartener, elementary school student, middle school student, or high school student).

Further, the information on the user's predicted correct answer rate according to one embodiment of the invention may be generated with reference to the user's learning level related to a subject corresponding to the at least one problem (e.g., a math subject may correspond to a problem related to divisors and multiples).

For example, the user's learning level according to one embodiment of the invention may include at least one of the user's academic achievement and past learning history (e.g., correct answer rates recorded by the user when using past problems of the subject).

As another example, the user's learning level according to one embodiment of the invention may be acquired from at least one of a database associated with the information provision system 200 (e.g., a database where student history information is stored, or a database related to student records) and an external system (e.g., the National Education Information System (NIES) of the Office of Education).

Further, the information on the predicted correct answer rate of the user (e.g., a first user) for the at least one problem (e.g., a first problem) according to one embodiment of the invention may be generated with reference to an actual correctness/incorrectness result of at least one other user (e.g., a second user) for the at least one problem.

For example, according to one embodiment of the invention, a reference correct answer rate (e.g., the reference correct answer rate may be 90% if 9 out of 10 other users have correctly answered according to actual correctness/incorrectness results of the other users) may be calculated with reference to an actual correctness/incorrectness result of at least one other user for the first problem (e.g., correct answer rates for the first problem of other users included in a specific user group associated with the user), and the information on the user's predicted correct answer rate for the first problem may be generated with further reference to the user's learning level (e.g., the user's predicted correct answer rate may be 95% if the reference correct answer rate is 90% and the user's academic achievement is the second highest among ten users in a specific user group associated with the user).

As another example, according to one embodiment of the invention, a weighted correct answer rate corresponding to the user's learning level may be determined (e.g., the weighted correct answer rate may be +10% if the user's academic achievement is the highest among ten users in a specific user group associated with the user, may be +0% if it is the fifth highest among the ten users, and may be −10% if it is the ninth highest among the ten users), and the predicted correct answer rate for the first problem may be determined by summing the reference correct answer rate and the weighted correct answer rate (e.g., the predicted correct answer rate may be determined as 70% if the reference correct answer rate is 80% and the weighted correct answer rate is −10%).

Therefore, the information on the user's predicted correct answer rate for the first problem according to one embodiment of the invention may be generated with reference to at least one of the user's learning level for the first problem and the actual correctness/incorrectness result of at least one other user for the first problem, and the area display unit 210 may display the information on the user's predicted correct answer rate in the area assigned to each of the at least one problem. Further, according to the invention, the user may easily identify his/her predicted correct answer rate for a specific problem (e.g., the first problem), which may enable efficient learning.

As another example, the information on the user's predicted correct answer rate according to one embodiment of the invention may be generated by a correctness/incorrectness prediction system (not shown). Here, the correctness/incorrectness prediction system according to one embodiment of the invention may comprise an information acquisition unit (not shown) and a probability calculation unit (not shown). Further, the correctness/incorrectness prediction system according to one embodiment of the invention may be included in the information provision system 200 or included in at least one of a database associated with the information provision system 200 and an external system.

For example, the correctness/incorrectness prediction system according to one embodiment of the invention may generate the information on the user's predicted correct answer rate by acquiring a set of data including a user variable determined on the basis of concept-specific correctness/incorrectness sequence data of at least one user, and at least one variable related to a problem and a concept associated with the user variable, and calculating a probability that a first user corresponding to a specific user variable correctly answers a first problem corresponding to a specific concept, with reference to the data set. The method for generating the information on the user's predicted correct answer rate by the correctness/incorrectness prediction system according to the invention will be described in detail below.

However, it will be apparent to those skilled in the art that the method for generating (or calculating) the information on the user's predicted correct answer rate according to the invention is not limited to those described above, but may be carried out in various ways as long as the objects of the invention may be achieved.

Further, the area assigned to the at least one problem according to one embodiment of the invention may include a specific area on a display of the device 300.

For example, the area assigned to the at least one problem according to one embodiment of the invention may include a specific area on the display of the device 300 of an administrator (e.g., a teacher) for managing the user's problem solving results.

Next, the display status determination unit 220 according to one embodiment of the invention may function to dynamically determine display status of the area assigned to a first problem with reference to the user's predicted correct answer rate for the first problem and the user's actual correctness/incorrectness result for the first problem.

Specifically, when the user solves the first problem and provides a problem solving result to the information provision system 200, the user's actual correctness/incorrectness result for the first problem according to one embodiment of the invention may be acquired by comparing a correct answer corresponding to the first problem with the user's problem solving result.

Further, the display status determination unit 220 according to one embodiment of the invention may dynamically determine the display status of the area assigned to the first problem with reference to a degree to which the user's actual correctness/incorrectness result for the first problem is close to the user's predicted correct answer rate for the first problem.

For example, the degree to which the user's actual correctness/incorrectness result for the first problem is close to the user's predicted correct answer rate for the first problem may be determined by calculating a difference between a predetermined specific value corresponding to the user's actual correctness/incorrectness result (e.g., the predetermined specific value may be 0 if the user answers correctly, and may be 1 if the user answers incorrectly) and the user's predicted correct answer rate (e.g., if the predicted correct answer rate is 80% and the user fails to answer the first problem correctly, the degree of closeness to the predicted correct answer rate may be determined as 0.2 by subtracting 0.8 from 1). Here, according to one embodiment of the invention, as the display status of the area assigned to the first problem is dynamically determined according to the degree to which the user's actual correctness/incorrectness result is close to the user's predicted correct answer rate for the first problem, the user may easily identify how close the problem solving result is to the predicted correct answer rate. However, the method for calculating the degree to which the user's actual correctness/incorrectness result for the first problem is close to the user's predicted correct answer rate for the first problem according to the invention is not limited to those described above, but may be diversely changed as long as the objects of the invention may be achieved.

As another example, in response to the degree to which the user's actual correctness/incorrectness result for the first problem is close to the user's predicted correct answer rate for the first problem being less than a predetermined level, the display status determination unit 220 according to one embodiment of the invention may show the display status of the area assigned to the first problem with more emphasis compared to display status of the areas assigned to other problems. Here, in response to the degree to which the user's actual correctness/incorrectness result for the first problem is close to the user's predicted correct answer rate for the first problem being not less than a predetermined level, the display status determination unit 220 according to one embodiment of the invention may show the display status of the area assigned to the first problem with less emphasis compared to display status of the areas assigned to other problems.

As a specific example, according to one embodiment of the invention, if the degree to which the user's actual correctness/incorrectness result for the first problem is close to the user's predicted correct answer rate for the first problem (e.g., if the user's predicted correct answer rate for the first problem is 89% and the user fails to answer the first problem correctly, the degree of closeness to the predicted correct answer rate may be determined as 0.11 by subtracting 0.89 from 1)) is less than a predetermined level (e.g., 0.5), the user could have correctly answered the first problem but may have failed to correctly answer due to various reasons (e.g., due to a calculation error), considering the user's learning level. Here, the display status determination unit 220 according to one embodiment of the invention may show the display status of the area assigned to the first problem with more emphasis compared to display status of the areas assigned to other problems, thereby inducing the user to review the first problem (e.g., since the user may have incorrectly answered the first problem by mistake, the user may be induced to review the first problem and correct the mistake).

As another specific example, according to one embodiment of the invention, if the degree to which the user's actual correctness/incorrectness result for the first problem is close to the user's predicted correct answer rate for the first problem (e.g., if the user's predicted correct answer rate for the first problem is 30% and the user answers the first problem correctly, the degree of closeness to the predicted correct answer rate may be determined as 0.3 by subtracting 0 from 0.3) is less than a predetermined level (e.g., 0.5), it could have been difficult for the user to correctly answer the first problem but the user may have correctly answered due to various reasons (e.g., due to randomly selecting an answer option and correctly answering by chance), considering the user's learning level. Here, the display status determination unit 220 according to one embodiment of the invention may show the display status of the area assigned to the first problem with more emphasis compared to display status of the areas assigned to other problems, thereby inducing the user to review the first problem (e.g., since the user may have correctly answered the first problem by chance, the user may be induced to review and accurately understand the first problem).

As another specific example, according to one embodiment of the invention, if the degree to which the user's actual correctness/incorrectness result for the first problem is close to the user's predicted correct answer rate for the first problem (e.g., if the user's predicted correct answer rate for the first problem is 80% and the user answers the first problem correctly, the degree of closeness to the predicted correct answer rate may be determined as 0.8 by subtracting 0 from 0.8) is not less than a predetermined level (e.g., 0.5), the user has solved the first problem in compliance with the user's predicted correct answer rate for the first problem, so that the display status of the area assigned to the first problem may be shown with less emphasis compared to display status of the areas assigned to other problems.

Therefore, according to the invention, the display status of the area is shown with less emphasis when the user solves the problem in compliance with the user's predicted correct answer rate, and shown with more emphasis otherwise, allowing the user to easily identify contents that needs to be reviewed regarding the user's problem solving result.

In addition, the method for showing the display status of the area according to one embodiment of the invention with more emphasis (or with less emphasis) may be carried out by using at least one element among a color, shape, picture, video, animation, and still image of the area assigned to the at least one problem, but it should be understood that the element is not limited to those described above but the display status may be dynamically determined using various elements.

Further, in response to the user's answer to a second problem not being submitted, the display status determination unit 220 according to one embodiment of the invention may show display status of the area assigned to the second problem with less emphasis compared to display status of the areas assigned to other problems.

For example, in response to the user's answer to the first problem being submitted and the user's answer to the second problem not being submitted, the display status determination unit 220 according to one embodiment of the invention may show the display status of the area assigned to the first problem with more emphasis compared to the display status of the area assigned to the second problem, and show the display status of the area assigned to the second problem with less emphasis compared to the display status of the area assigned to the first problem.

Therefore, the display status determination unit 220 may show the area assigned to a problem for which an answer has been submitted (e.g., the first problem) with more emphasis compared to a problem for which an answer has not been submitted (e.g., the second problem), so that the user (or administrator) may focus more on reviewing the problem for which the answer has been submitted.

Meanwhile, according to one embodiment of the invention, the information on the user's predicted correct answer rate for the first problem may be updated with reference to the user's actual correctness/incorrectness result for the first problem.

For example, according to one embodiment of the invention, if it is determined that the user's learning level has increased in view of the user's actual correctness/incorrectness result for the first problem, the information on the user's predicted correct answer rate for the first problem may be updated.

As another example, according to one embodiment of the invention, if it is determined that the user's learning level has increased in view of the user's actual correctness/incorrectness result for the first problem (e.g., if the number of times the degree to which the actual correctness/incorrectness result is close to the predicted correct answer rate is less than a predetermined level, as the user correctly answers in recent problem solving results, is not less than a predetermined number), the information on the user's predicted correct answer rate for the second problem may be updated (e.g., updated to a higher predicted correct answer rate than the existing predicted correct answer rate for the second problem). Meanwhile, according to one embodiment of the invention, if it is determined that the user's learning level has decreased in view of the user's actual correctness/incorrectness result for the first problem (e.g., if the number of times the degree to which the actual correctness/incorrectness result is close to the predicted correct answer rate is less than a predetermined level, as the user incorrectly answers in recent problem solving results, is not less than a predetermined number), the information on the predicted correct answer rate for the second problem may be updated (e.g., updated to a lower predicted correct answer rate than the existing predicted correct answer rate for the second problem).

As another example, according to one embodiment of the invention, a reference correct answer rate for the first problem may be updated with reference to an actual correctness/incorrectness result of a first user for the first problem (e.g., updated by recalculating an average correct answer rate of a user group to which the first user belongs with further reference to the actual correctness/incorrectness result of the first user). In this case, information on a predicted correct answer rate of a second user who has not yet solved the first problem may be updated.

However, the method for updating the information on the user's predicted correct answer rate according to the invention is not limited to those described above, but the information on the user's predicted correct answer rate may be updated by acquiring information associated with the user's predicted correct answer rate or learning level from an external database or external system (not shown).

Next, the communication unit 230 according to one embodiment of the invention may function to enable data transmission/reception from/to the area display unit 210 and the display status determination unit 220.

Lastly, the control unit 240 according to one embodiment of the invention may function to control data flow among the area display unit 210, the display status determination unit 220, and the communication unit 230. That is, the control unit 240 according to one embodiment of the invention may control data flow into/out of the information provision system 200 or data flow among the respective components of the information provision system 200, such that the area display unit 210, the display status determination unit 220, and the communication unit 230 may carry out their particular functions, respectively.

Hereinafter, it will be described in detail how to generate information on a user's predicted correct answer rate for at least one problem.

### Correctness/Incorrectness Prediction System

A correctness/incorrectness prediction system (not shown) according to one embodiment of the invention may function to acquire a set of data including a user variable determined on the basis of concept-specific correctness/incorrectness sequence data of at least one user, and at least one variable related to a problem and a concept associated with the user variable, and to calculate a probability that a first user corresponding to a specific user variable correctly answers a first problem corresponding to a specific concept, with reference to the data set.

Further, the correctness/incorrectness prediction system according to one embodiment of the invention may comprise a data acquisition unit and a probability calculation unit.

First, the data acquisition unit according to one embodiment of the invention may acquire a set of data including a user variable determined on the basis of concept-specific correctness/incorrectness sequence data of at least one user, and at least one variable related to a problem and a concept associated with the user variable.

According to one embodiment of the invention, the concept-specific correctness/incorrectness sequence data may be generated with reference to data on a result of at least one user solving at least one problem associated with at least one concept.

Further, according to one embodiment of the invention, the concept-specific correctness/incorrectness sequence data may be generated by preprocessing for performing concept-specific categorization with respect to the data on the result of solving the at least one problem associated with the at least one concept.

For example, according to one embodiment of the invention, the concept-specific correctness/incorrectness sequence data may be generated by preprocessing data on a result of solving problems to indicate correctness or incorrectness for each concept included in a problem solved in a time-series manner by each user. According to one embodiment of the invention, the concept-specific categorization for the at least one problem may be performed on the basis of concept-specific tagging made by an expert in the relevant field. Further, according to another embodiment of the invention, the concept-specific categorization for the at least one problem may be performed on the basis of a natural language processing (NLP) algorithm and a clustering algorithm.

Specifically, according to one embodiment of the invention, the concept-specific categorization for the at least one problem may be performed by tagging the at least one problem by concept with reference to a lookup table that is pre-created by the expert to categorize concepts (e.g., which may refer to a lookup table in which concepts are pre-categorized for each problem). Further, according to one embodiment of the invention, the concept-specific categorization for the at least one problem may be performed with reference to the lookup table using an NLP algorithm and a clustering algorithm.

Meanwhile, the user variable according to one embodiment of the invention refers to user identification information that allows a user to be identified, and may include a user ID. For example, the user ID may be expressed as a series of identification numbers (e.g., natural numbers) that may represent a user. Specifically, according to one embodiment of the invention, the natural identification numbers may be assigned in ascending order according to the order in which the user solves given problems.

Further, the problem-related variable according to one embodiment of the invention refers to problem identification information that allows a problem to be identified, and may include a problem identification number. For example, the problem identification number may be assigned to each problem on the basis of the sequence of curriculum units to be learned by the user.

Furthermore, the concept-related variable according to one embodiment of the invention refers to concept identification information that allows a concept to be identified, and may include a concept identification number and a concept understanding level. For example, the concept identification number may be assigned to each concept on the basis of the sequence of concepts to be learned by the user.

Specifically, the data acquisition unit according to one embodiment of the invention may acquire a data set in a matrix structure for the user variable determined on the basis of the concept-specific correctness/incorrectness sequence data, and the problem-related variable and concept-related variable associated with the user variable.

More specifically, with respect to a specific problem solved by a specific user, the matrix-structured data set according to one embodiment of the invention may be expressed as including data represented as 1s and 0s regarding whether the specific problem includes (or is associated with) a specific concept, a concept understanding level, and data represented as 1s and 0s regarding a result of solving the specific problem. In the data set according to one embodiment of the invention, a row may have a structure of [user ID, problem identification number, whether a concept is included, user's understanding of each concept, and result of problem solving].

For example, it may be assumed that the user ID is 213, the problem identification number is 340, the number of concepts that may be applied to all problems is limited to 5, the concepts included in the problem are first and fifth concepts, and the user correctly answers the problem. Here, in the matrix-structured data set according to one embodiment of the invention, a row may be expressed as [213, 340, 1, 0, 0, 0, 0, 1, 0.6, 0.4, 0.3, 0.3, 0.65, 1].

Further, the user variable or the problem-related variable included in the data set according to one embodiment of the invention may be grouped on the basis of at least one piece of context information.

Specifically, according to one embodiment of the invention, the user variable may be specified into a user group on the basis of demographic information of users (e.g., age, gender, major, grade level, and residence), and the data acquisition unit may acquire the data set on the basis of the specified user group. For example, users with the same age, gender, major, and grade level may be categorized into a first user group. As another example, users may be categorized into a second user group in consideration of time spent solving problems, date of last access, and the like.

Further, according to one embodiment of the invention, the problem-related variable may be specified into a problem group on the basis of problem attribute information, and the data acquisition unit may acquire the data set on the basis of the specified problem group. The problem attribute information according to one embodiment of the invention refers to information indicating unique attributes of a problem, and may include information on a recommended grade level, a recommended major, scoring, a problem type (e.g., multiple choice or essay), presence or absence of an image, and the like.

Through the foregoing, it is possible to make a correctness/incorrectness prediction for a new user and a new problem as the user variable and the problem-related variable are grouped on the basis of context information, respectively.

Meanwhile, the structure of the data set according to the invention is not necessarily limited according to the above-described variables, and the variables and the structure of the data set may be diversely changed as long as the objects of the invention may be achieved.

Meanwhile, the concept-related variable included in the data set according to one embodiment of the invention may include the user's concept understanding, which is estimated using a concept-specific understanding estimation model trained on the basis of the concept-specific correctness/incorrectness sequence data.

A concept-specific understanding estimation model according to one embodiment of the invention may be trained on the basis of the concept-specific correctness/incorrectness sequence data.

For example, the concept-specific understanding estimation model according to one embodiment of the invention may be trained using a Bayesian knowledge tracing algorithm. Herein, the Bayesian knowledge tracing algorithm may refer to an algorithm that probabilistically models a learner's cognitive processes during the course of learning to trace the learner's level of knowledge acquisition at a given time point.

According to one embodiment of the invention, the concept-specific understanding estimation model may be trained with respect to a plurality of parameters (e.g., pre-existing knowledge, acquired knowledge, a guess, and a mistake) on the basis of the concept-specific correctness/incorrectness sequence data. According to one embodiment of the invention, the pre-existing knowledge indicates a probability that the user already possesses the knowledge, the acquired knowledge indicates a probability that the user fully understands the knowledge by solving a problem, the guess indicates a probability that the user guesses a correct answer to the problem without possessing the knowledge, and the mistake indicates a probability that the user possesses the knowledge but makes a mistake. Further, according to one embodiment of the invention, the plurality of parameters may be updated on the basis of an expectation maximization algorithm.

According to one embodiment of the invention, the concept-specific understanding estimation model may be trained such that the concept-specific understanding is estimated by assigning a greater weight to second sequence data generated at a second time point (e.g., following a first time point by a predetermined amount of time) than to first sequence data generated at the first time point.

For example, according to one embodiment of the invention, the second sequence data may be assigned a greater weight than the first sequence data on the basis of a weighting function.

More specifically, the weighting function according to one embodiment of the invention may be expressed as Equation 1 below.

$${w}_{tl} = \frac{{d}^{t - l}}{{\sum }_{l = 1}^{t - 1} {d}^{t - l}} ∈ ( 0 , 1 ] \qquad ( EQ . 1 )$$

Here, wₜ₁ denotes a weight assigned to the l^{th} sequence data out of t pieces of sequence data, and d denotes a user-defined constant. For example, d may be set to 0.7. As another example, d may be set to a value that is observed to have the smallest error during the course of assessing the concept-specific understanding estimation model.

This allows the concept-specific understanding estimation model to more precisely estimate the user's concept understanding by assigning a greater weight to more recent sequence data, reflecting the degree of forgetting a concept over time after solving a problem.

Further, the conventional Bayesian knowledge tracing algorithm is based on the assumption that a user does not forget knowledge once learned, and has a limitation that individual characteristics (e.g., difficulty) of problems cannot be considered. However, according to one embodiment of the invention, the concept-specific understanding estimation model may be trained with respect to the plurality of parameters with reference to the weighted concept-specific correctness/incorrectness sequence data, so that the user's concept understanding may be more precisely identified compared to the conventional Bayesian knowledge tracing algorithm.

Meanwhile, the concept-specific understanding estimation model according to the invention is not necessarily limited to being trained by the above algorithm, and the training algorithm may be diversely changed as long as the objects of the invention may be achieved.

According to the invention, a concept understanding estimation model may be built not only using the above concept-specific correctness/incorrectness sequence data, but also using concept-specific correctness/incorrectness sequence data of two or more users so that the model may be applied to the two or more users. Therefore, the concept understanding estimation model may reflect learning experiences of multiple learners, thereby providing concept understanding estimation results with high reliability and universality.

Further, according to one embodiment of the invention, the user's concept understanding may be estimated using a concept-specific understanding estimation model that is trained on the basis of the concept-specific correctness/incorrectness sequence data. Specifically, according to one embodiment of the invention, a user's understanding of a concept (or concept understanding) may refer to a probability that the user knows the concept at a given time point (e.g., at time point t+1) on the basis of the concept-specific correctness/incorrectness sequence data (e.g., the data through time point t).

Further, according to one embodiment of the invention, when a particular user has never solved a problem about a specific concept, the user's understanding of the concept may be set to 0.5.

Meanwhile, according to one embodiment of the invention, the user's understanding of a concept that the user has not encountered may be estimated.

For example, according to one embodiment of the invention, a first user's understanding of a second concept may be estimated on the basis of a second user's understanding of the second concept.

More specifically, according to one embodiment of the invention, learning levels of the first user and the second user may be assessed by comparing concept understanding of the first user and the second user with respect to a plurality of concepts that the first user has already encountered. Next, the first user's understanding of the second concept may be estimated on the basis of the assessed learning levels of the first and second users and the second user's concept correctness/incorrectness sequence data for the second concept.

As another example, according to one embodiment of the invention, the user's understanding of a concept that the user has not encountered may be estimated by assessing the similarity between the concept that the user has not encountered and a concept that the user has already solved.

For example, a simulated annealing algorithm may be applied to a first problem containing a second concept not encountered by the user and a second problem containing a first concept encountered by the user, thereby assessing the similarity between the first and second concepts. According to one embodiment of the invention, on the basis of the assessed similarity between the concepts, the user's understanding of the concept not encountered by the user may be estimated from the user's understanding of the concept encountered by the user.

Meanwhile, according to one embodiment of the invention, the user's understanding of a concept not encountered by the user may be estimated on the basis of a collaborative filtering algorithm.

For example, the user's understanding of the concept not encountered by the user may be estimated using a matrix factorization algorithm on the concept-specific correctness/incorrectness sequence data represented in a matrix structure with respect to a plurality of concepts (e.g., which may be a first concept encountered by the user and a second concept not encountered by the user) and results of a plurality of users solving problems. As another example, since the times at which the concept understanding is estimated for the plurality of users are different, the user's understanding of the concept not encountered by the user may be estimated using a temporal dynamics algorithm.

Further, according to one embodiment of the invention, the concept-specific understanding estimation model may be assessed using a result of estimating the user's concept understanding.

For example, according to one embodiment of the invention, the concept-specific understanding estimation model may be assessed on the basis of a k-fold cross validation algorithm. Specifically, the k-fold cross validation algorithm according to one embodiment of the invention refers to an algorithm for assessing the model by successively alternating training and validation steps, such that all the concept correctness/incorrectness sequence data is assessed. Meanwhile, the concept-specific understanding estimation model according to the invention is not necessarily limited to being assessed by the above algorithm, and the assessment algorithm for optimizing the model may be diversely changed as long as the objects of the invention may be achieved.

Next, the probability calculation unit according to one embodiment of the invention may calculate a probability that a user corresponding to a specific user variable correctly answers a problem corresponding to a specific concept, with reference to the acquired data set.

For example, the probability according to one embodiment of the invention may refer to a conditional probability calculated using a binary classification algorithm. Specifically, the probability calculation unit according to one embodiment of the invention may train a binary classification model on the basis of the user variable, the problem-related variable, and the concept-related variable (e.g., the user's concept understanding estimated using the concept-specific understanding estimation model trained on the basis of the concept-specific correctness/incorrectness sequence data) included in the data set, and use the trained model to calculate a probability that the user correctly answers a specific problem. For example, the binary classification model may be a logistic regression model, a multi-layer perceptron (MLP), or a support vector machine (SVM).

More specifically, the probability calculation unit according to one embodiment of the invention may train a binary classification model through the data set in which the user variable and the problem-related variable are grouped on the basis of context information (e.g., demographic information and problem attribute information) to calculate a probability that a new user correctly answers a new problem using the trained model, without having to separately designate or specify a variable for the new user or the new problem.

Meanwhile, the binary classification model according to the invention is not necessarily limited to the above model, and may be diversely changed as long as the objects of the invention may be achieved.

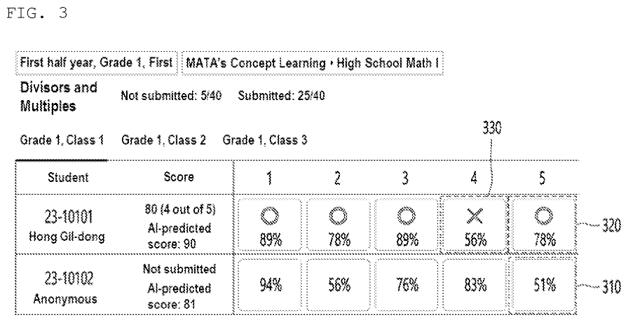

Hereinafter, it will be described in detail with reference to FIG. 3 how to visualize problem solving results according to one embodiment of the invention.

### Embodiments

FIG. 3 illustratively shows a situation in which problem solving results are visualized according to one embodiment of the invention.

Referring to FIG. 3, the area display unit 210 according to one embodiment of the invention may display information on a user's predicted correct answer rate for at least one problem in an area assigned to the at least one problem. Here, problem solving results of two or more users may be displayed together on one dashboard.

Next, the display status determination unit 220 may dynamically determine display status of a third area 330 assigned to a first problem (e.g., problem 4) with reference to a predicted correct answer rate (e.g., 56%) of a first user (e.g., student Hong Gil-dong) for the first problem and an actual correctness/incorrectness result of the first user for the first problem (e.g., a result of failing to answer correctly).

Further, the display status determination unit 220 may dynamically determine display status of a second area 320 assigned to a second problem (e.g., problem 5) with reference to a predicted correct answer rate (e.g., 78%) of the first user (e.g., student Hong Gil-dong) for the second problem and an actual correctness/incorrectness result of the first user for the second problem (e.g., a result of answering correctly).

Meanwhile, the area display unit 210 may display a predicted correct answer rate (e.g., 51%) of a second user (e.g., an anonymous student) for the second problem (e.g., problem 5) in a first area 310 assigned to the second problem. Here, in response to the second user's answer to the second problem being not submitted, the display status determination unit 220 may show the display status of the area assigned to the second problem with less emphasis compared to display status of the areas assigned to other problems.

Further, in response to a degree to which the actual correctness/incorrectness result of the first user for the first problem is close to the predicted correct answer rate of the first user for the first problem being less than a predetermined level, the display status determination unit 220 may show the display status of the area assigned to the first problem with more emphasis compared to display status of the areas assigned to other problems.

Further, information on the predicted correct answer rate of the first user for the second problem may be updated with reference to the actual correctness/incorrectness result of the first user for the second problem (e.g., a result that student Hong Gil-dong has correctly answered problem 5).

Here, an average correct answer rate for the second problem of a user group to which the first user belongs (e.g., a group including users belonging to class 1 in grade 1) may be updated with reference to the actual correctness/incorrectness result of the first user for the second problem, and information on the predicted correct answer rate of at least one of the first user and the second user may be updated with reference to the average correct answer rate (e.g., a reference correct answer rate).

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks, and magnetic tapes; optical media such as compact disk-read only memory (CD-ROM) and digital versatile disks (DVDs); magneto-optical media such as floptical disks; and hardware devices such as read-only memory (ROM), random access memory (RAM), and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### DESCRIPTION OF THE REFERENCE NUMERALS

100: communication network
200: information provision system
210: area display unit
220: display status determination unit
230: communication unit
240: control unit
300: device
310: first area
320: second area
330: third area

1. A method for visualizing problem solving results, the method comprising the steps of:
displaying information on a user's predicted correct answer rate for at least one problem in an area assigned to each of the at least one problem; and
dynamically determining display status of the area assigned to a first problem with reference to the user's predicted correct answer rate for the first problem and the user's actual correctness/incorrectness result for the first problem.

2. The method of claim 1, wherein in the determining step, the display status of the area assigned to the first problem is dynamically determined with reference to a degree to which the user's actual correctness/incorrectness result for the first problem is close to the user's predicted correct answer rate for the first problem.

3. The method of claim 1, wherein in the determining step, in response to a degree to which the user's actual correctness/incorrectness result for the first problem is close to the user's predicted correct answer rate for the first problem being less than a predetermined level, the display status of the area assigned to the first problem is shown with more emphasis compared to display status of the areas assigned to other problems.

4. The method of claim 1, wherein in the determining step, in response to the user's answer to a second problem being not submitted, display status of the area assigned to the second problem is shown with less emphasis compared to display status of the areas assigned to other problems.

5. The method of claim 1, wherein the information on the user's predicted correct answer rate for the first problem is generated with reference to an actual correctness/incorrectness result of at least one other user for the first problem.

6. The method of claim 1, wherein the information on the user's predicted correct answer rate for the first problem is updated with reference to the user's actual correctness/incorrectness result for the first problem.

7. A non-transitory computer-readable recording medium having stored thereon a computer program for executing the method of claim 1.

8. A system for visualizing problem solving results, the system comprising:
an area display unit configured to display information on a user's predicted correct answer rate for at least one problem in an area assigned to each of the at least one problem; and
a display status determination unit configured to dynamically determine display status of the area assigned to a first problem with reference to the user's predicted correct answer rate for the first problem and the user's actual correctness/incorrectness result for the first problem.

9. The system of claim 8, wherein the display status determination unit is configured to dynamically determine the display status of the area assigned to the first problem with reference to a degree to which the user's actual correctness/incorrectness result for the first problem is close to the user's predicted correct answer rate for the first problem.

10. The system of claim 8, wherein the display status determination unit is configured to, in response to a degree to which the user's actual correctness/incorrectness result for the first problem is close to the user's predicted correct answer rate for the first problem being less than a predetermined level, show the display status of the area assigned to the first problem with more emphasis compared to display status of the areas assigned to other problems.

11. The system of claim 8, wherein the display status determination unit is configured to, in response to the user's answer to a second problem being not submitted, show display status of the area assigned to the second problem with less emphasis compared to display status of the areas assigned to other problems.

12. The system of claim 8, wherein the information on the user's predicted correct answer rate for the first problem is generated with reference to an actual correctness/incorrectness result of at least one other user for the first problem.

13. The system of claim 8, wherein the information on the user's predicted correct answer rate for the first problem is updated with reference to the user's actual correctness/incorrectness result for the first problem.
